(19) United States
(12) Patent Application Publication
(10) Pub. No.: US 2026/0131572 A1
(43) Pub. Date: May 14, 2026

(54) LIQUID EJECTION HEAD AND METHOD OF MANUFACTURING LIQUID EJECTION HEAD

(71) Applicant: CANON KABUSHIKI KAISHA, Tokyo (JP)

(72) Inventor: RYOTARO MURAKAMI, Kanagawa (JP)

(21) Appl. No.: 19/385,426

(22) Filed: Nov. 11, 2025

(30) Foreign Application Priority Data
Nov. 12, 2024 (JP) 2024-197746

(51) Int. Cl. B41J 2/14; B41J 2/16; B41J 2/20

(52) U.S. Cl. CPC B41J 2/1433; B41J 2/14233; B41J 2/162; B41J 2/20; B41J 2002/14306; B41J 2002/14419

(57) ABSTRACT

A liquid ejection head of the present disclosure includes: a nozzle flow path including a nozzle for ejecting a liquid; and an individual supply flow path for supplying the liquid, the individual supply flow path being orthogonally connected to the nozzle flow path at an end portion of the nozzle flow path in a longitudinal direction, in which the nozzle flow path includes, at the end portion, a wall in a direction in which the individual supply flow path is connected, and the wall has an inclination.

### BACKGROUND

### Field of the Technology

The present disclosure relates to a liquid ejection head and a method of manufacturing the liquid ejection head.

### Description of the Related Art

A micro electro mechanical system (MEMS) device is produced by joining members in which grooves or through holes serving as liquid flow paths are formed. As an example thereof, a liquid ejection head that ejects a liquid onto a print medium is included.

The liquid ejection head includes an energy generating element that gives energy to eject a liquid such as ink. As the energy generating element, an element that heats and boils the liquid, such as a heater element, an element that applies a pressure to the liquid by using a change in volume, such as a piezo element, and the like are included.

In regard to a liquid ejection head, a liquid ejection device that ejects a liquid in a pressure chamber from a nozzle as described in Japanese Patent Laid-Open No. 2021-119042 is known.

The liquid ejection head includes a nozzle flow path connected to the nozzle, a supply flow path for supplying the liquid, and the like. In a case where the nozzle flow path and the supply flow path are connected at a right angle, the liquid may stagnate near a connecting portion (angular portion) of these flow paths, and concentration of the liquid may occur. Such concentration of the liquid may lead to a possibility that ejection performance of the liquid from the nozzle is degraded.

### SUMMARY

The present disclosure is directed to suppress concentration of a liquid in a nozzle flow path and improve liquid ejection performance.

A liquid ejection head of the present disclosure includes: a nozzle flow path including a nozzle configured to eject a liquid; and an individual supply flow path configured to supply the liquid, the individual supply flow path being orthogonally connected to the nozzle flow path at an end portion of the nozzle flow path in a longitudinal direction, in which the nozzle flow path includes, at the end portion, a wall in a direction in which the individual supply flow path is connected, and the wall has an inclination.

Features of the present disclosure will become apparent from the following description of embodiments with reference to the attached drawings. The following description of embodiments is described by way of example.

### BRIEF DESCRIPTION OF THE DRAWINGS

FIG. 1 is a sectional perspective view illustrating a configuration example of a liquid ejection head of the present disclosure;

FIG. 2A is an enlarged sectional view illustrating a region (1A) of the liquid ejection head in FIG. 1;

FIG. 2B is a sectional view illustrating a shape of a nozzle flow path of the liquid ejection head of the present disclosure;

FIG. 2C is a sectional view illustrating an example of a liquid ejection head in the related art;

FIGS. 3A and 3B are top views illustrating, as an example, of the shape of the nozzle flow path of the liquid ejection head of the present disclosure;

FIG. 4 is a top view illustrating another example of the shape of the nozzle flow path of the liquid ejection head of the present disclosure;

FIGS. 5A to 5D are partial sectional views for describing the shape of the nozzle flow path of the liquid ejection head of the present disclosure;

FIG. 6 is a schematic sectional view illustrating an example of the liquid ejection head of the present disclosure;

FIG. 7 is a schematic sectional view illustrating another example of the liquid ejection head of the present disclosure;

FIG. 8 is a schematic sectional view illustrating another example of the liquid ejection head of the present disclosure;

FIG. 9 is schematic view illustrating parts of a process of manufacturing the liquid ejection head of the present disclosure;

FIG. 10 is schematic view illustrating parts of the process of manufacturing the liquid ejection head of the present disclosure;

FIG. 11 is schematic view illustrating parts of the process of manufacturing the liquid ejection head of the present disclosure;

FIG. 12 is schematic view illustrating parts of a different process of manufacturing the liquid ejection head of the present disclosure;

FIG. 13 is schematic view illustrating parts of the different process of manufacturing the liquid ejection head of the present disclosure;

FIG. 14 is schematic view illustrating parts of a process of manufacturing a different liquid ejection head of the present disclosure;

FIG. 15 is schematic view illustrating parts of the process of manufacturing the different liquid ejection head of the present disclosure; and

FIG. 16 is schematic view illustrating parts of the process of manufacturing the different liquid ejection head of the present disclosure.

### DESCRIPTION OF THE EMBODIMENTS

A liquid ejection head of the present disclosure will be described below with reference to the drawings. Hereinafter, the present disclosure will be described in detail on the basis of specific embodiments. Although there may be specific descriptions in the description, the specific descriptions illustrate examples that can be adopted in terms of technical aspects and are not intended to limit the scope of the present disclosure, in particular.

Although a liquid ejection head that ejects a liquid such as ink will be described as an example in the following description, the present disclosure is not limited to the example. The liquid ejection head of the present disclosure can be applied to apparatuses such as a printer, a copy machine, a facsimile with a communication system, and a word processor with a printer unit, and industrial print apparatuses that are combined with various processing apparatuses in a composite manner. For example, the liquid ejection head can also be used for applications such as production of biochips or printing of electronic circuits. The liquid to be ejected is also not limited to the ink.

### Overview of Present Disclosure

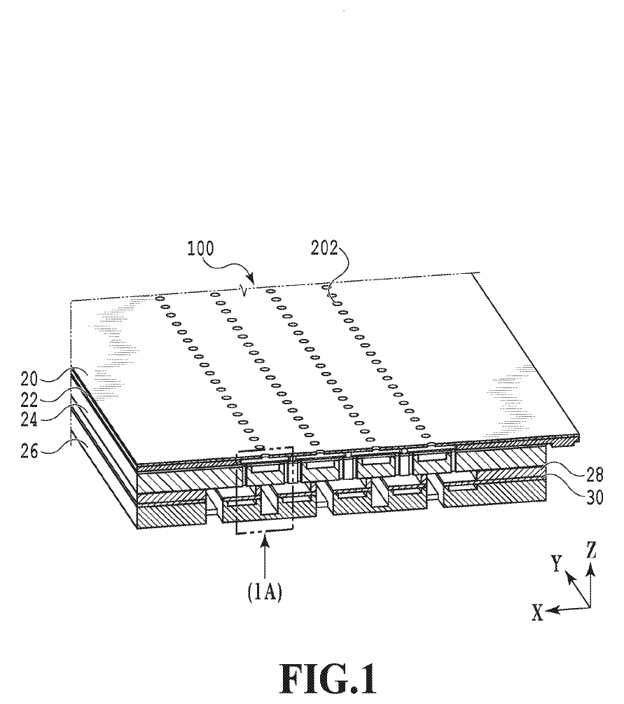

The liquid ejection head of the present disclosure includes a nozzle flow path including a nozzle, a supply flow path for supplying the liquid, and the like. For example, FIG. 1 is a schematic diagram illustrating a configuration of a part of the liquid ejection head of the present disclosure. The liquid ejection head in FIG. 1 is an example of a liquid ejection head including a circulation system. Specifically, a liquid ejection head 100 includes five substrates, namely a nozzle forming substrate 20, a vibrating substrate 22, a liquid supply substrate 24, a flow path forming substrate 26, and a damper substrate 28. The liquid ejection head 100 has a structure in which the damper substrate 28 including a damper member 30 is attached between the flow path forming substrate 26 and the liquid supply substrate 24. The nozzle forming substrate 20 includes nozzles (ejection ports) 202.

In the description of the present disclosure, directions may be defined by an X axis, a Y axis, and a Z axis. These axes are indicated by direction axes with arrows illustrated in each drawing. The direction in which the arrow of the axis in each direction is directed will be defined as a "+" direction of each axis. Also, in a case where the direction of each axis is mentioned without specifying the "+" or "-" direction of the axis, the direction will be simply referred to as an "X-axis direction", a "Y-axis direction", or a "Z-axis direction". In the description that mentions the nozzle flow path of the present disclosure, the direction in which the liquid flows through the nozzle flow path will be defined as a "first direction". In the present disclosure, the direction which is the "first direction" and does not specify the side of "+" or "-" will be referred to as a "longitudinal direction" of the nozzle flow path. In the embodiments of the present disclosure, the "longitudinal direction" indicates the "X-axis direction", in particular. Moreover, the direction orthogonal to (perpendicularly intersecting) the "first direction", that is, the direction directed to the side of the nozzle in the nozzle flow path will be defined as a "second direction" or a "+Z" direction. In an embodiment of the present disclosure, the nozzle flow path corresponds to a flow path in a first direction. In an embodiment of the present disclosure, an individual supply flow path in a liquid supply flow path corresponds to a flow path perpendicularly intersecting the longitudinal direction (or the first direction) of the nozzle flow path. In an embodiment of the present disclosure, an individual collecting flow path in a liquid collecting flow path corresponds to a flow path perpendicularly intersecting the longitudinal direction (or the first direction) of the nozzle flow path. In an embodiment of the present disclosure, the individual supply flow path is connected orthogonally to the nozzle flow path at an end portion of the nozzle flow path in the longitudinal direction (this connecting portion will also be referred to as a first connecting portion). In an embodiment of the present disclosure, the individual collecting flow path is connected orthogonally to the nozzle flow path at an end portion of the nozzle flow path opposite to the end portion where the first connecting portion is present (this connecting portion will also be referred to as a second connecting portion). In the present disclosure, the direction in which the nozzle flow path and the liquid supply flow path (particularly, the individual supply flow path) or the liquid collecting flow path (particularly, the individual collecting flow path) are connected at the first connecting portion and the second connecting portion will also be referred to as a "connecting direction". In an embodiment of the present disclosure, the "connecting direction" can be orthogonal. In the present disclosure, a pair of opposite end portions are present in the longitudinal direction of the nozzle flow path, and the first connecting portion is present at one of these end portions while the second connecting portion is present at the other end portion. In the present disclosure, the nozzle flow path includes walls in the second direction at the two opposite end portions. In other words, the nozzle flow path includes walls orthogonal to the longitudinal direction of the nozzle flow path at the two opposite end portions. Out of these walls, the wall at the end portion where the first connecting portion is present will be referred to as a first wall, while the wall at the other end portion where the second connecting portion is present will also be referred to as a second wall. The liquid ejection head of the present disclosure is characterized by the structure of the nozzle flow path. The nozzle flow path of the present disclosure is characterized by including the walls in the first direction (the +X direction in FIG. 1) and the second direction (the +Z direction in FIG. 1) with the wall in the second direction having an inclination.

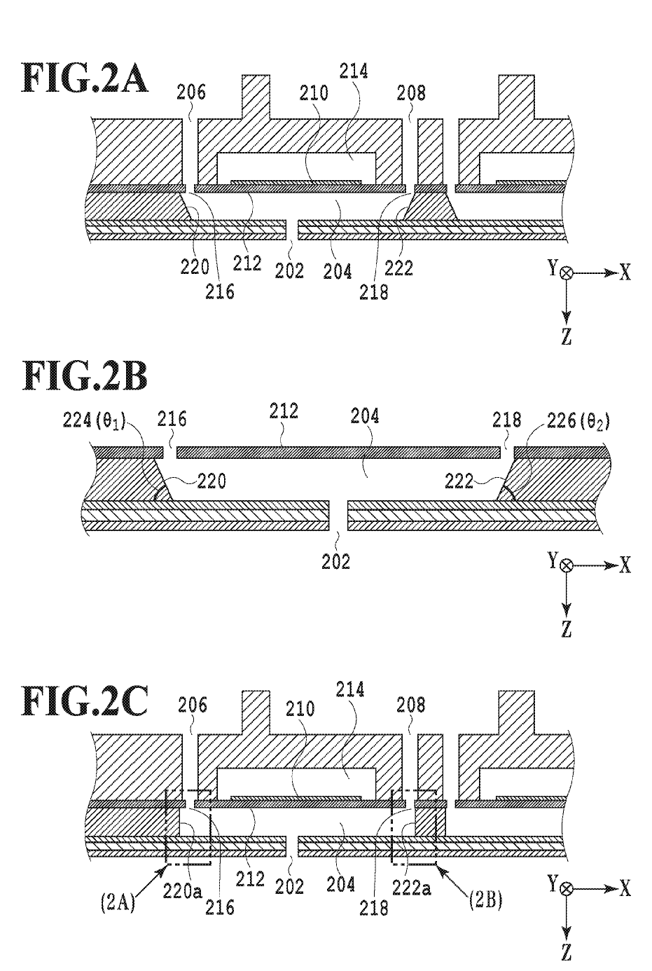

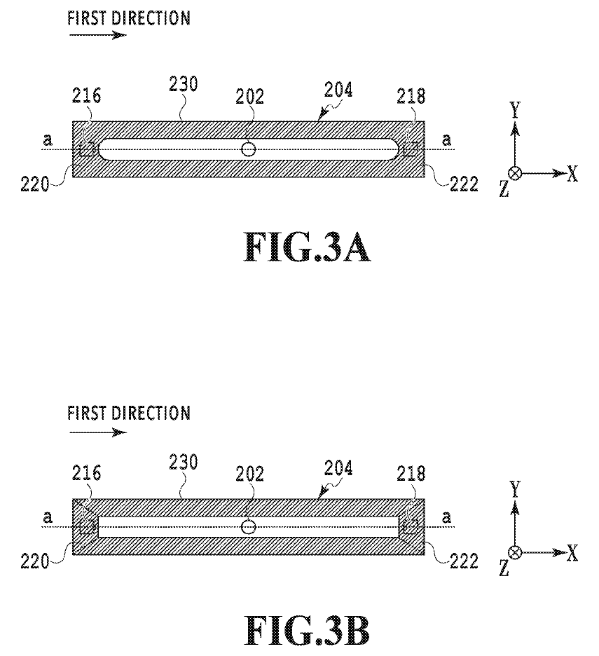

Hereinafter, features of the liquid ejection head of the present disclosure will be specifically described with reference to FIGS. 2A to 2C, 3A and 3B.

In the following description with reference to FIGS. 2A-2C, 3A, and 3B, a liquid ejection head including a circulation system will be described as a configuration example of the liquid ejection head of the present disclosure. However, the present disclosure can also be applied to a liquid ejection head that does not include the circulation system.

FIG. 2A is an enlarged sectional view of a region (1A) part in FIG. 1. The liquid ejection head of the present disclosure includes nozzle flow paths 204 including the nozzles 202, individual supply flow paths 206, and individual collecting flow paths 208. In the example of FIG. 2A, energy generating elements 210, vibrating plates 212, individual cavities 214 can be included in addition to the configurations of these nozzle flow paths. The liquid ejection head of the present disclosure further includes openings 216 at connecting portions between the nozzle flow paths 204 and the individual supply flow paths 206. Moreover, the liquid ejection head of the present disclosure includes openings 218 at connecting portions between the nozzle flow paths 204 and the individual collecting flow paths 208. Walls 220 and 222 of each nozzle flow path 204 are present near each opening 216 and near each opening 218. The liquid ejection head of the present disclosure is characterized by the walls 220 and 222 being provided with inclinations. Note that in a specific embodiment of the present disclosure, the connecting portion between each nozzle flow path 204 and each individual supply flow path 206 corresponds to the first connecting portion while the connecting portion between each nozzle flow path 204 and each individual collecting flow path 208 corresponds to the second connecting portion. In the specific embodiment of the present disclosure, the wall 220 of the nozzle flow path 204 that is present near the opening 216 corresponds to the first wall. Also, the wall 222 of the nozzle flow path 204 that is present near the opening 218 corresponds to the second wall.

Next, the liquid ejection head of the present disclosure will be described in more detail with reference to FIG. 2B. FIG. 2B is an enlarged sectional view of each nozzle flow path 204 in the liquid ejection head of the present disclosure.

The liquid ejection head of the present disclosure includes the opening 216 at the connecting part between the nozzle flow path 204 and the individual supply flow path 206 as illustrated in FIG. 2B. The wall 220 of the nozzle flow path 204 is present near the opening 216. The wall 220 has an inclination in the longitudinal direction (also referred to as the "first direction" in the present specification) of the nozzle flow path 204. Note that the direction (first direction) from the wall 220 to the wall 222 corresponds to the direction in which the liquid flows in the present specification. In the present disclosure, the nozzle flow path 204 is provided with the wall (hereinafter, also referred to as an inclined surface) 220 with such an inclination. The flow of the liquid passing through the nozzle flow path 204 and the individual supply flow path 206 is smoothed, and stagnation of the liquid on the connecting surface is reduced, by providing such an inclined surface 220 at the connecting portion between the nozzle flow path 204 and the individual supply flow path 206. In this manner, concentration of the liquid in the nozzle flow path 204 is reduced, and performance of ejecting the liquid from a nozzle 202 can be improved.

In the present disclosure, it is only necessary for the inclined surface to be provided on the wall where the connecting portion (the part corresponding to the opening 216) between the nozzle flow path 204 and the individual supply flow path 206 is present as illustrated in FIG. 2B. Alternatively, it is possible to provide inclined surfaces on walls of the nozzle flow path 204, which are walls where the connecting portions between the nozzle flow path 204 and the individual supply flow path 206 and between the nozzle flow path 204 and the individual collecting flow path 208 (the parts corresponding to the opening 216 and the opening 218) are present. In other words, the inclined surface 220 out of the inclined surfaces at the two locations illustrated in FIG. 2B may be provided alone or both the inclined surfaces 220 and 222 may be provided in an embodiment of the present disclosure. It is possible to further improve the performance of ejecting the liquid from the nozzle by providing the inclined surfaces at the two locations.

As illustrated in FIG. 2B, the inclined surface 220 has an angle 224 (θ₁) formed with a surface of the nozzle flow path where the nozzle 202 is formed in the nozzle flow path 204 of the present disclosure. Also, the inclined surface 222 has an angle 226 (θ₂) formed with the surface of the nozzle flow path where the nozzle 202 is formed in the nozzle flow path 204 of the present disclosure. These angles 224 (θ₁) and 226 (θ₂) can be each independently equal to or greater than 25° and less than 90°. Although the angles 224 (θ₁) and 226 (θ₂) may be the same angle or different angles, the angles 224 (θ₁) and 226 (θ₂) can be the same angle from the viewpoint of a process of manufacturing the nozzle flow path.

Here, the shape of a typically used nozzle flow path will be described as a comparative example with reference to FIG. 2C. In a liquid ejection head of the comparative example, walls 220a and 222a of the nozzle flow path are orthogonal surfaces at connecting parts between the nozzle flow path 204 and the individual supply flow path 206 and between the nozzle flow path 204 and the individual collecting flow path 208. The direction of a flow of a liquid flowing in the flow paths is changed by 90° at such connecting parts (for example, angular parts such as a region (2A) and a region (2B) in FIG. 2C). In such a case, the liquid may stagnate at the connecting portions of the flow paths, and the liquid may be concentrated near the connecting portions. If concentration of the liquid occurs in the nozzle flow path that is the closest to the nozzle, there is a possibility that performance of ejecting the liquid may be significantly degraded as compared with a case where the liquid is concentrated in other flow paths. The present disclosure is directed to suppress such degradation of the performance of ejecting the liquid.

The nozzle flow path provided with the inclined surfaces of the present disclosure will be described in more detail with reference to FIGS. 3A and 3B. As a material of the nozzle flow path provided with the inclined surfaces of the present disclosure, a silicon substrate or the like is used.

FIG. 3A is a diagram illustrating an embodiment of the nozzle flow path of the present disclosure. As illustrated in FIG. 3A, the inclinations of the nozzle flow path can be provided such that the width of the four walls of the nozzle flow path is narrowed toward the surface where the nozzle is formed in the present disclosure. It is possible to form the nozzle flow path with the shape as in FIG. 3A by setting an etching time at the time of forming the flow path to be shorter than the time in a case where the walls of the nozzle flow path are formed to be orthogonal, for example.

In the present disclosure, the angles (θ₁ and θ₂) of the inclined surfaces 220 and 222 are defined as angles seen in the section a-a in FIG. 3A.

The nozzle flow path of the present embodiment can be produced using a bosch process, which is a type of reactive ion etching, for example. In this embodiment, inclined surfaces of the nozzle flow path 204 can also be formed on surfaces 230 of the nozzle flow path in the flow path direction, in addition to the inclined surfaces 220 and 222 of the nozzle flow path 204 illustrated in FIG. 2B. The nozzle flow path of the present disclosure can also be formed by a method of combining wet etching with an alkaline aqueous solution and laser hole processing or the like.

FIG. 3B is a diagram illustrating another embodiment of the nozzle flow path of the present disclosure. This embodiment is an example in which the nozzle flow path 204 is produced using a silicon substrate having a crystal plane (100). The nozzle flow path 204 can be produced by the above-described method. In this embodiment, inclinations are also formed on the surfaces 230 (hereinafter, also referred to as side surfaces of the nozzle flow path) of the nozzle flow path in the flow path direction. In the present embodiment, the inclined surfaces of the nozzle flow path 204 are formed as the inclined surfaces 220 and 222 of the nozzle flow path 204 illustrated in FIG. 2B and the side surfaces of the nozzle flow path, and the nozzle flow path 204 has a truncated square pyramid shape. In the present embodiment, the inclined surfaces 220 and 222 and the side surfaces of the nozzle flow path have the same inclination angle. For example, the inclination angle of the inclined surfaces 220 and 222 in the section along the line a-a in FIG. 3B is 54.7°.

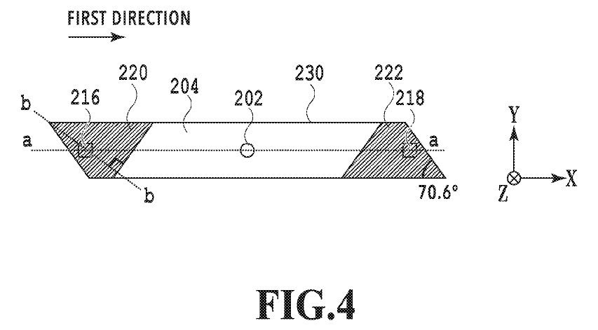

FIG. 4 is a diagram illustrating another embodiment of the nozzle flow path of the present disclosure. This embodiment is an example in which the nozzle flow path 204 is produced using a silicon substrate having a crystal plane (110). In this embodiment, the inclined surfaces 220 and 222 of the nozzle flow path are inclined surfaces in a direction that is different from the direction (the first direction or the +X direction in FIG. 4) in which the liquid flows in the nozzle flow path 204. For example, the inclined surfaces 220 and 222 are inclined surfaces along the line b-b as illustrated in FIG. 4. For example, the inclined surfaces 220 and 222 in the section along the line b-b in FIG. 4 have an angle of 35.3°. On the other hand, the inclination angle thereof in the section along the line a-a is 28.1°. Here, the angles (θ₁ and θ₂) of the inclined surfaces are the angles seen in the section along the direction of the line a-a (the X-axis direction in FIG. 4) of the nozzle flow path even in the case where the inclined surfaces are inclined in the direction different from the X-axis direction of the nozzle flow path as in the present embodiment.

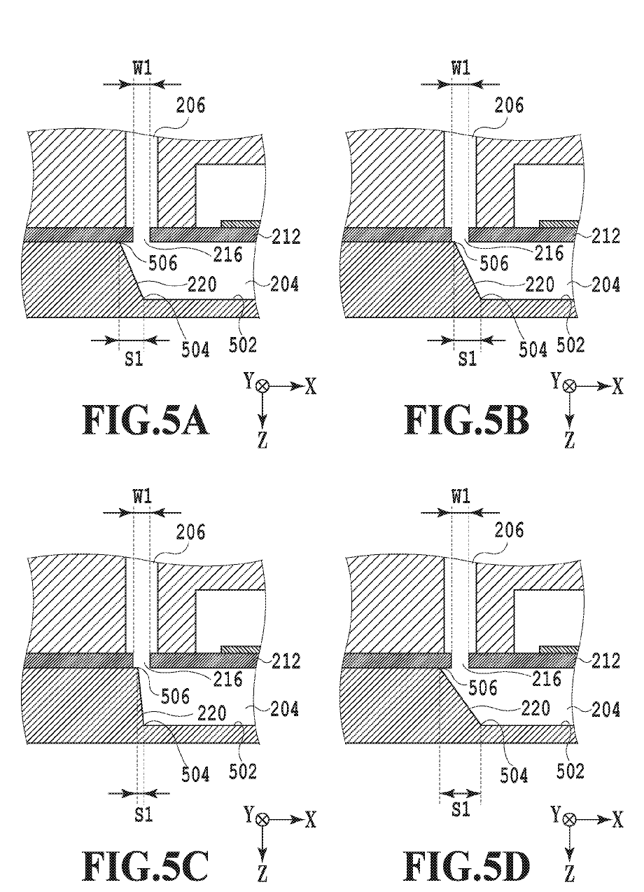

The positional relationship between the inclined surfaces 220 and 222 of the nozzle flow path 204 and the openings 216 and 218 will be described with reference to FIGS. 5A-5D. Although FIGS. 5A-5D illustrate, as an example, the inclined surface 220 and the opening 216 and describe the positional relationship therebetween, the same applies to the positional relationship between the inclined surface 222 of the nozzle flow path 204 and the opening 218.

As illustrated in FIGS. 5A-5D, the opening width of the opening 216, which is connected to the nozzle flow path, in the X-axis direction is defined as W1. Also, as illustrated in drawings of FIGS. 5A-5D, the width of the inclination in the section of the inclined surface 220 of the nozzle flow path in the X-axis direction (that is, at the position of the line a-a and in the direction of the line a-a in FIGS. 3A, 3B, and 4) is defined as S1.

As the positional relationship between W1 and S1, the following embodiments as in FIGS. 5A-5D can be adopted.

(1) FIG. 5A:

FIG. 5A is an embodiment in which the width W1 of the opening 216 and the width S1 of the inclined surface 220 partially overlap each other. In this embodiment, a position 504 at which the inclined surface 220 is in contact with a surface 502 of the nozzle flow path 204 where the nozzle is present is located within the width W1. On the other hand, an end portion 506 of the inclined surface 220 on the side of the opening 216 is located at a place deviating from the width W1 in the -X direction.

(2) FIG. 5B:

FIG. 5B is another embodiment in which the width W1 of the opening 216 and the width S1 of the inclined surface 220 partially overlap each other. In this embodiment, the position 504 at which the inclined surface 220 is in contact with the surface 502 of the nozzle flow path 204 where the nozzle is present is located at a place deviating from the width W1 in the +X direction (first direction). On the other hand, the end portion 506 of the inclined surface 220 on the side of the opening 216 is located within the width W1.

(3) FIG. 5C:

FIG. 5C is an embodiment in which both the end portion 506 of the inclined surface 220 on the side of the opening 216 and the position 504 of the contact with the surface 502 of the nozzle flow path 204 where the nozzle is present fall within the range of the width W1.

(4) FIG. 5D:

FIG. 5D is an embodiment in which both the end portion 506 of the inclined surface 220 on the side of the opening 216 and the position 504 of the contact with the surface 502 of the nozzle flow path 204 where the nozzle is present are located outside the width W1.

In the present disclosure, all of the embodiments in FIGS. 5A-5D can be adopted. Although the embodiment illustrated in FIGS. 5B or 5C in which the vibrating plate 212 does not serve as a visor at the opening 216 can be adopted, the width of the opening 216 is narrowed. Therefore, it is important to appropriately set a relationship between W1 and S1. On the other hand, although the vibrating plate 212 serves as a visor in the embodiment illustrated in FIGS. 5A or 5D, the opening 216 is not narrowed. Even in the embodiments in which a visor is formed, it is possible to generate a flow directed to the side of a part below the visor (the side of the inclined surface 220) as a shadow of the vibrating plate 212 with respect to the direction in which the liquid flows, by setting a small angle for the inclined surface. It is thus possible to suppress stagnation of the liquid at the visor part. Therefore, it is important to appropriately set the relationship between W1 and S1 in these cases as well.

If the width S1 becomes large with respect to the width W1, then the sectional area of the nozzle flow path 204 in the Z-axis direction (second direction) is narrowed, and a region in which the liquid passes through the nozzle flow path is narrowed. Furthermore, the inclination of the inclined surface 220 becomes gentle in the aspect in which the width S1 is large with respect to the width W1. This means that a component of the liquid in the +X direction (first direction) of the nozzle flow path is reduced in a case where the direction of the flow of the liquid is changed by the inclined surface 220. Such reduction makes the flow of the liquid in the +X direction gentle and thus increases the possibility that stagnation of the liquid may occur in the nozzle flow path.

From the above-described viewpoint, the relationship between the width W1 and the width S1 can be within a range of (S1/W1) < 4 (where S1 < 0 and W1 < 0) in order to maintain the effect of reducing stagnation by providing the inclined surface 220 in the present disclosure.

FIGS. 5A-5D illustrate embodiments of a case where the width of the opening 216 is narrower than the width of the individual supply flow path 206 are illustrated. Therefore, the width of the opening 216 (the width between the two vibrating plates 212 sandwiching the individual supply flow path 206) is defined as W1. In contrast, in a case where the width between the two vibrating plates 212 sandwiching the individual supply flow path 206 is wider than the individual supply flow path 206 (the opening 216 has the same width as that of the individual supply flow path 206), the width of the individual supply flow path is W1.

The liquid ejection head including the above-described nozzle flow path will be described below.

### 1. Liquid Ejection Head

Hereinafter, specific embodiments of the liquid ejection head including the nozzle flow path of the present disclosure will be described. Note that the following embodiments are examples illustrating configurations of the liquid ejection head of the present disclosure and are not intended to limit the present disclosure.

### First Embodiment

The present embodiment is an example of a liquid ejection head including the nozzle flow path of the present disclosure and including a liquid circulation system such as a liquid supply flow path, a liquid collecting flow path, and the like.

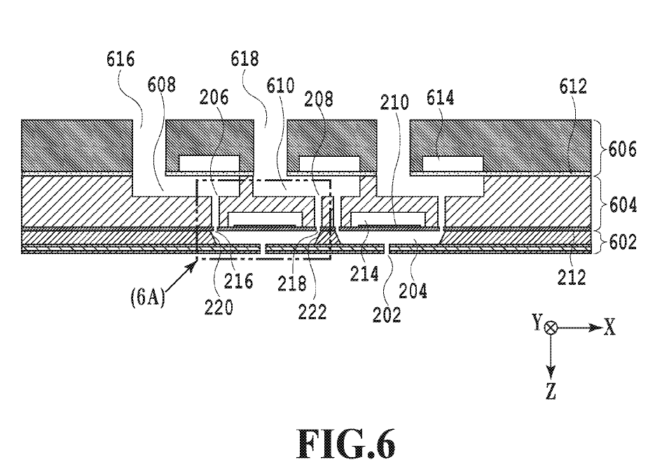

The liquid ejection head of the present embodiment will be described with reference to FIG. 6. The liquid ejection head of the present embodiment includes a first flow path substrate 602, a second flow path substrate 604, and a third flow path substrate 606.

The first flow path substrate 602 is a substrate including the nozzle flow paths 204 of the present disclosure. The first flow path substrate 602 includes the nozzles 202, the nozzle flow paths 204, and the inclined surfaces 220 and 222 of the nozzle flow paths with inclinations. The liquid ejection head of the present disclosure can be provided with the plurality of nozzle flow paths. The nozzle flow paths 204 included in the first flow path substrate include the configuration of the nozzle flow paths described in the section of "SUMMARY".

Since the present embodiment includes the liquid circulation system, the liquid ejection head includes the individual supply flow paths 206 and the individual collecting flow paths 208. In an embodiment of the liquid ejection head with such a configuration, the nozzle flow paths 204 in the first flow path substrate can include both the inclined surfaces 220 and 222. In another embodiment, the nozzle flow paths in the first flow path substrate can include the inclined surfaces 220 alone. In the present disclosure, both the inclined surfaces 220 and 222 can be included in the nozzle flow paths 204 such that stagnation and concentration of the liquid can be further prevented.

The second flow path substrate 604 includes the individual supply flow paths 206, the individual collecting flow paths 208, the energy generating elements 210, the vibrating plates 212, and the individual cavities 214. The second flow path substrate 604 further includes first common supply flow paths 608 and a first common collecting flow path 610.

The vibrating plates 212 include electrical connecting portions (not illustrated) to which the energy generating elements 210, driver ICs, and the like are connected. The vibrating plates 212 includes openings 216 and 218 for connecting to the nozzle flow paths 204 of the present disclosure at the positions of the individual supply flow paths 206 and the individual collecting flow paths 208. In the second flow path substrate 604, a material of a substrate in which the individual supply flow paths 206, the individual collecting flow paths 208, the individual cavities 214, and the like are formed can be, for example, a silicon substrate.

In the liquid ejection head of the present disclosure, it is possible to provide the plurality of individual supply flow paths 206, individual collecting flow paths 208, energy generating elements 210, vibrating plates 212, and individual cavities 214 in accordance with the number of nozzles in the liquid ejection head.

In the present embodiment, piezoelectric elements can be included as an example of the energy generating elements 210. The piezoelectric elements include lower electrodes formed on the vibrating plates, piezoelectric elements formed on the lower electrodes, and upper electrodes formed on the piezoelectric elements.

The liquid ejection head of the present embodiment includes a circulation system in which the liquid flows in from the individual supply flow paths 206 and the liquid is collected by the individual collecting flow paths 208.

The liquid ejection head of the present embodiment includes a third flow path substrate 606. The third flow path substrate includes dampers 612 that reduce variations in rear pressure at the time of liquid ejection and damper cavities 614 for making the dampers 612 movable. As a material of the dampers 612, an elastic member can be used. Examples of the elastic member can include resin members such as polyimide and polyamide. Also, it is possible to use a silicon substrate or the like as a substrate of the third flow path substrate 606.

The third flow path substrate 606 further includes second common supply flow paths 616 and a second common collecting flow path 618 that are connected to the first common supply flow paths 608 and the first common collecting flow path 610 of the second flow path substrate, respectively.

In the liquid ejection head of the present disclosure, the liquid is supplied from the second common supply flow paths 616 and the first common supply flow paths 608 to the nozzle flow paths 204 through the individual supply flow paths 206. The liquid receives a pressure from the vibrating plates 212 and is ejected as liquid droplets from the nozzles 202 of the nozzle flow paths 204. The liquid remaining after the liquid is ejected is collected through the individual collecting flow paths 208, the first common collecting flow path 610, and the second common collecting flow path 618. According to the liquid ejection head of the present disclosure, it is possible to prevent stagnation of the liquid in the nozzle flow path, to thereby reduce concentration of the liquid, and to prevent degradation of quality of the ejected liquid, by providing the inclined surfaces 220 and 222 in the nozzle flow paths 204.

### Second Embodiment

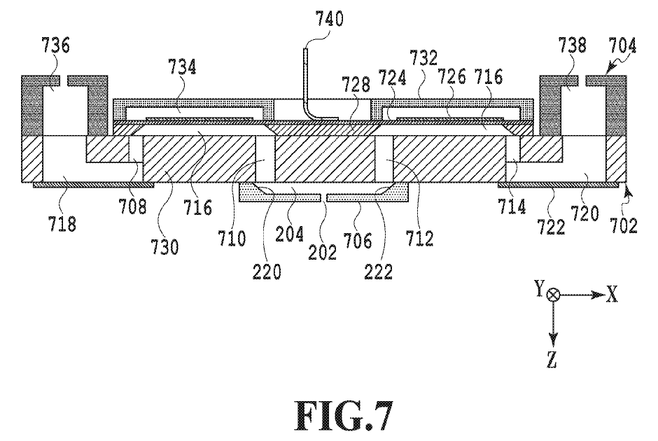

A liquid ejection head of a second embodiment will be described using FIG. 7.

The liquid ejection head of the second embodiment includes a first flow path substrate 702, a second flow path substrate 704, and an individual nozzle flow path 706. The structure of the individual nozzle flow path 706 is similar to that in the first embodiment other than that a nozzle flow path is provided in the form of a single body including one nozzle.

The first flow path substrate 702 includes a plurality of individual flow paths 708, 710, 712, and 714 and pressure chambers 716 as illustrated in FIG. 7. The first flow path substrate 702 further includes common flow paths 718 and 720, dampers 722, and the like. It is possible to use a silicon substrate or the like as a substrate 730 of the first flow path substrate in which each of the above flow paths is formed.

The first flow path substrate 702 includes a vibrating plate 724 and energy generating elements 726. The first flow path substrate 702 includes a pressure chamber substrate 728. The pressure chamber substrate 728 forms the pressure chambers 716 by the vibrating plate 724, the energy generating elements 726, and a part of the substrate 730 of the first flow path substrate between the individual flow paths 708 and 710, for example. The vibrating plate 724 and the energy generating elements 726 are protected in individual cavities 734 by protective substrates 732. As the protective substrates, it is possible to use silicon substrates or the like. The second flow path substrate 704 includes flow paths 736 and 738 connected to the common flow paths 718 and 720. A material of the second flow path substrate 704 includes a silicon substrate or the like. Also, the liquid ejection head of the second embodiment can include a wiring substrate 740.

### Third Embodiment

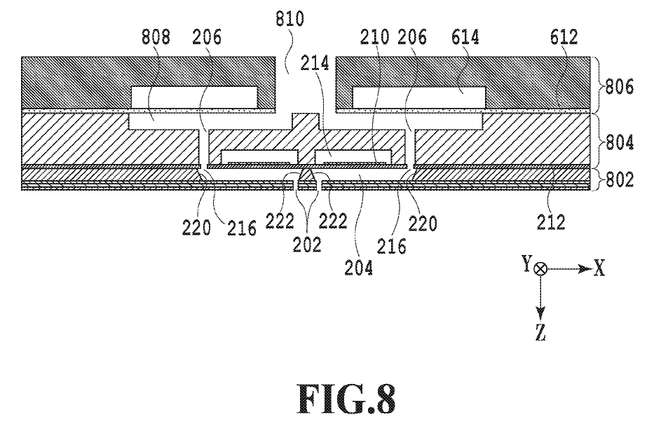

A third embodiment is an example of a liquid ejection head that does not include a circulation system that collects and circulates a liquid, such as an individual collecting flow path, a first common collecting flow path, and a second common collecting flow path. The third embodiment will be described with reference to FIG. 8.

In the third embodiment, the liquid ejection head includes a first flow path substrate 802, a second flow path substrate 804, and a third flow path substrate 806.

In the present embodiment, the first flow path substrate 802 is a substrate including nozzle flow paths 204. As illustrated in FIG. 8, nozzles 202 are provided at an end portion of the nozzle flow path 204 on the side opposite to the position of openings 216 in the first flow path substrate 802 of the present embodiment. Although the nozzle flow paths 204 have horizontally symmetrical forms with respect to the center part in FIG. 8, the present embodiment is not limited thereto.

In the present embodiment, the structure of each element in the nozzle flow paths other than the nozzles 202 in the first flow path substrate 802 is similar to that in the first embodiment.

The second flow path substrate 804 of the present embodiment includes individual supply flow paths 206, energy generating elements 210, vibrating plates 212, and individual cavities 214. The second flow path substrate 804 further includes first common supply flow paths 808.

Configurations and materials of the energy generating elements 210, the vibrating plates 212, the individual cavities 214, and the like are as described in the first embodiment.

In the liquid ejection head of the present disclosure, it is possible to provide the plurality of individual supply flow paths 206, energy generating elements 210, vibrating plates 212, and individual cavities 214 in accordance with the number of nozzles in the liquid ejection head.

The third flow path substrate 806 includes the dampers 612, the damper cavities 614, and a second common supply flow path 810. In the third flow path substrate, the damper cavities 614 are provided at positions corresponding to the individual supply flow paths 206.

Other configurations, materials, and the like of the liquid ejection head of the third embodiment are similar to those described in the first embodiment.

### Method of Manufacturing Liquid Ejection Head

A method of manufacturing the liquid ejection head of the present disclosure will be described below. Hereinafter, the first embodiment to the third embodiment of the liquid ejection heads described above will be described as examples.

### First Embodiment of Method of Manufacturing Liquid Ejection Head

The liquid ejection head of the first embodiment includes the first flow path substrate 602, the second flow path substrate 604, and the third flow path substrate 606 as illustrated in FIG. 6. The liquid ejection head of the first embodiment can be manufactured by producing each of the first flow path substrate, the second flow path substrate, and the third flow path substrate and then attaching them to each other. Hereinafter, processes of manufacturing the first flow path substrate, the second flow path substrate, and the third flow path substrate will be described in order.

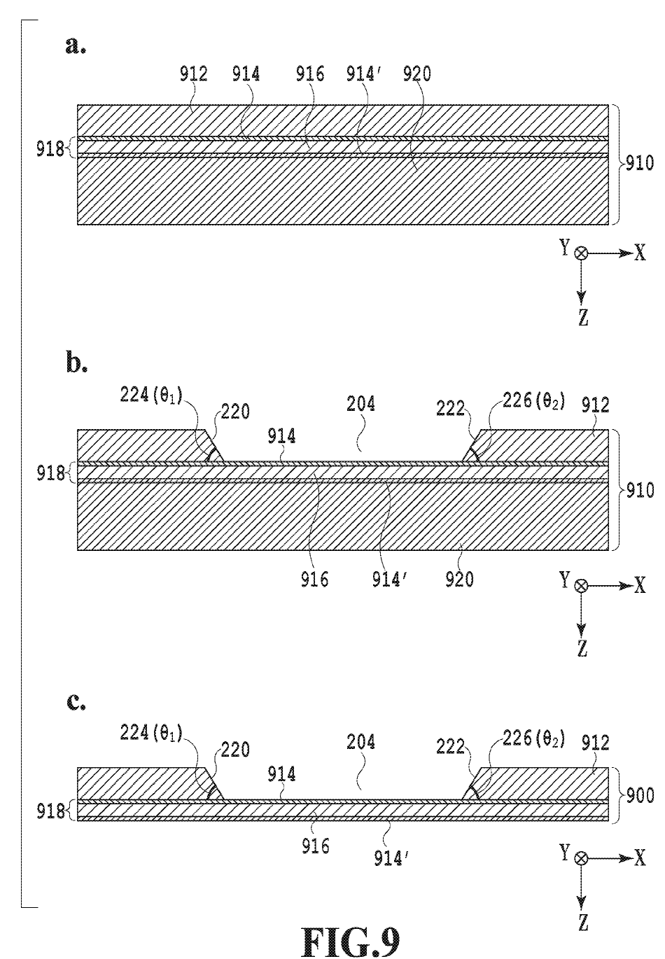

First, the process of producing the first flow path substrate 602 will be described with reference to FIGS. 9a-9c. As illustrated in FIG. 9a, a nozzle flow path forming substrate 910 is provided. The nozzle flow path forming substrate 910 includes a nozzle flow path layer 912, a nozzle forming layer 918 including a silicon on insulator (SOI) substrate including oxide films 914 and 914' and a silicon layer 916, and a support substrate 920. Each of these layers can be obtained or prepared by a known procedure, and the nozzle flow path forming substrate 910 can be prepared in accordance with a known procedure.

Next, the nozzle flow paths 204 are formed in the nozzle flow path forming substrate 910. The inclined surfaces 220 and 222 of the opposite inclined walls of the nozzle flow paths 204 in the flow path direction (X-axis direction) are formed. A method of providing the inclined surfaces in the nozzle flow paths includes a bosch process known as a type of reactive ion etching. The bosch process is a method of forming an etched groove that is orthogonal to a substrate by alternately performing coating and etching on a material to be etched. In the reactive ion etching, etching is performed by accelerated ions. An apparatus for the etching is divided into a plasma source for generating ions and a reaction chamber for performing etching. For example, it is possible to use an inductively coupled plasma (ICP) dry etching apparatus that can output ions at a high density from an ion source. In a case where this apparatus is used, it is possible to form an etched groove that is orthogonal to a substrate to be etched by alternately performing coating and etching. As etching gas, it is possible to use, for example, SF₆ gas. Also, examples of gas for forming a passivation layer include C₄F₈ gas and CHF₃ gas.

In order to form the inclined surfaces 220 and 222 of the nozzle flow paths 204, an etching condition is set such that the width in the flow path direction (X-axis direction) becomes narrower toward an etching advancing direction (the +Z direction in FIG. 9) in the bosch process. For example, it is possible to perform the etching by setting a working time of the etching to be shorter than the time in a case where the walls of the nozzle flow path are orthogonally formed. The etching rate of the walls of the nozzle flow path is reduced by gradually shortening the working time. It is possible to narrow the width of the walls of the nozzle flow path layer 912 toward the etching advancing direction (+Z direction) by repeating the process. Note that the working time of the etching can be appropriately set by those skilled in the art in accordance with a desired angle for the inclined surfaces of the nozzle flow path.

In a case where the nozzle flow paths 204 are formed in accordance with the above etching procedure, the inclination angles (θ₁ and θ₂) of the inclined surfaces 220 and 222 can be set to be equal to or greater than 25° and less than 90°, for example. In one embodiment, the inclination angles can be set within a range of values equal to or greater than 50° and less than 90°. In one embodiment, the inclination angles can be set within a range of values equal to or greater than 70° and less than 90°. The definition and the like in regard to the angles of the inclined surfaces 220 and 222 are as described above with reference to FIG. 2B.

Examples of an etching method for forming the nozzle flow paths of the present disclosure include, in addition to the above method based on the reactive ion etching, a method of combining formation of a through hole by leaser on the flow path substrate and wet etching with an alkaline aqueous solution.

Examples of the alkaline aqueous solution for the wet etching include aqueous solutions of tetramethylammonium hydroxide (TMAH) and alkali metal hydroxide (for example, potassium hydroxide (KOH)).

In the case where the crystal plane of the silicon substrate in which the nozzle flow paths 204 are to be formed is a crystal plane (100) as described in FIGS. 3A and 3B, for example, the nozzle flow paths 204 illustrated in FIGS. 3A or 3B are formed in the present disclosure. In these described examples, the inclination angles (θ₁ and θ₂) of the inclined surfaces 220 and 222 of the nozzle flow paths 204 are 54.7°.

Also, in a case where the crystal plane of the silicon substrate in which the nozzle flow paths 204 are to be formed is a crystal plane (110), an inclined surface in the section along the line b-b illustrated in FIG. 4 is formed. Also, the inclination angle of the inclined surface in the section along the line b-b is 35.3°. The angles of the inclined surfaces in the section along the line a-a illustrated in FIG. 4 are 28.1°.

Next, production of the second flow path substrate 604 will be described. The second flow path substrate 604 includes the plurality of individual supply flow paths 206 and the plurality of individual collecting flow paths 208 as illustrated in FIG. 6. Also, the second flow path substrate 604 includes the first common supply flow paths 608 connected to the plurality of individual supply flow paths 206 and the first common collecting flow path 610 connected to the plurality of individual collecting flow paths 208. Furthermore, the second flow path substrate 604 includes the individual cavities 214 that accommodate the vibrating plates 212.

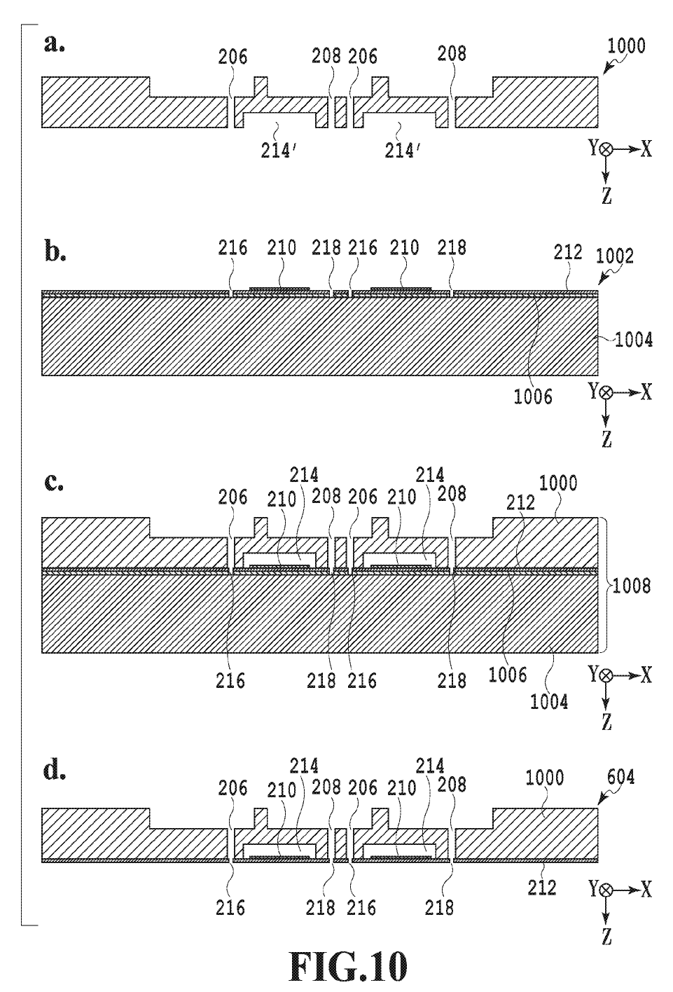

A process of producing the second flow path substrate 604 will be described with reference to FIGS. 10a-10d.

First, a flow path substrate 1000 illustrated in FIG. 10a is formed. In the flow path substrate 1000, the plurality of individual supply flow paths 206 and the plurality of individual collecting flow paths 208 are formed. In the flow path substrate 1000, parts including parts corresponding to the first common supply flow paths 608, a part corresponding to the first common collecting flow path 610, and parts 214' corresponding to the individual cavities are formed.

The flow path substrate 1000 can be produced from a silicon substrate, for example. Processing of each above-described flow path and the parts 214' corresponding to the individual cavities can be performed by a bosch process, which is a type of reactive ion etching. The bosch process is a method of forming an etched groove that is orthogonal to a substrate by alternately performing coating and etching on the material to be etched as described above. In addition to the method, the processing includes, for example, a method of thinning the substrate by forming a no-perforating hole in the substrate and back-grinding the substrate or through chemical mechanical polishing (CMP). It is possible to form a through hole corresponding to each flow path, the parts 214' corresponding to the individual cavities, and the like in the substrate by these methods. Furthermore, a method of processing the substrate by combining formation of through hole by leaser on the substrate and wet etching with an alkaline aqueous solution can be included as another processing method. Examples of the alkaline aqueous solution to be used for the wet etching include tetramethylammonium hydroxide (TMAH) and alkali metal hydroxide (for example, KOH).

Next, an actuator substrate 1002 illustrated in FIG. 10b is produced. The actuator substrate 1002 includes the energy generating elements 210, the vibrating plates 212, and wirings and electrical connecting portions (not illustrated) connecting the energy generating elements 210 to the driver ICs.

Examples of the energy generating elements 210 include piezoelectric elements. The piezoelectric elements include the lower electrodes (not illustrated) formed on the vibrating plates 212, the piezoelectric elements formed on the lower electrodes, and the upper electrodes (not illustrated) formed on the piezoelectric elements. The vibrating plates 212, the lower electrodes, and the upper electrodes are formed by, for example, plasma CVD. Piezoelectric bodies of the piezoelectric elements can be formed by a known method such as a sol-gel method or a sputtering method. As a material of the piezoelectric bodies, it is possible to use, for example, lead zirconate titanate (PZT). Such piezoelectric bodies can be in the form of sintered bodies of metal oxide crystals. Next, interlayer films, wirings, and the like are formed to enable the piezoelectric elements to be driven, thereby forming the actuator substrate 1002.

In the vibrating plates 212 of the actuator substrate 1002 and an oxide film 1006, the openings 216 and 218 corresponding to the individual supply flow paths 206 and the individual collecting flow paths 208 in the second flow path substrate 604 are provided. In a method of forming these openings, a resist film is formed on the actuator substrate 1002 first and is then patterned by photolithography. Next, the openings 216 and 218 are formed in the vibrating plates 212 and the oxide film 1006 by dry etching.

The flow path substrate 1000 illustrated in FIG. 10a and the actuator substrate 1002 illustrated in FIG. 10b are joined through wafer joining via an adhesive (FIG. 10c). As the adhesive, a material showing high adhesiveness to the substrate can be used. Also, a material with a small amount of air bubbles and the like mixed therein and with high coating performance can be adopted. Furthermore, a material with low viscosity to facilitate a decrease in thickness of the adhesive can be adopted. The adhesive can contain resin selected from epoxy resin, acrylic resin, silicone resin, benzocyclobutene resin, polyamide resin, polyimide resin, or urethane resin. A plurality of adhesives can be used in a mixed manner. Examples of a method of curing the adhesive include a thermal curing method and a UV delayed curing method. Note that in a case where any of the above-described substrates has UV-transmittivity, a UV curing method can also be used.

Examples of a method of applying the adhesive include an adhesive transfer method using a transfer substrate. Specifically, the transfer substrate is provided, and the adhesive is thinly and uniformly applied to the transfer substrate by a spin coating method or a slit coating method. Then, the adhesive is transferred only to an adhesive surface of the flow path substrate 1000 by bringing the adhesive surface of the flow path substrate 1000 into contact with the applied adhesive. As for the size, the transfer substrate can have the same dimension as that of the flow path substrate 1000 or can have a larger dimension than that of the flow path substrate 1000. As the transfer substrate, a substrate of an inorganic material including silicon, glass, or the like or a film including a resin such as polyethylene terephthalate (PET), polyethylene naphthalate (PEN), or polyimide (PI) can be used. In addition to the above-described method, it is also possible to employ a method of applying the adhesive directly to the flow path substrate 1000. Examples of such a method include screen printing and dispense coating.

Next, the flow path substrate 1000 with the adhesive applied thereto and the actuator substrate 1002 are joined. The joining is performed by warming each substrate to a predetermined temperature in a joining apparatus and then pressurizing them under a predetermined pressure for a predetermined period of time. Conditions of the joining are appropriately set in accordance with the material of the adhesive. Also, the substrates can be joined under vacuum from the viewpoint of reducing mixing of air bubbles into the joined portions.

In a case of a thermal curing adhesive, each substrate may be warmed until the adhesive is cured in the joining apparatus. Alternatively, after the substrates are joined in the joining apparatus, the joined substrates may be taken out from the apparatus and may be additionally warmed using an oven or the like to promote the curing of the adhesive.

In a case of a UV delayed adhesive, the adhesive is irradiated with a prescribed amount of ultraviolet rays in advance before the joining, and the substrates are then joined. Then, the each of the joined substrates can be further warmed to sufficiently promote the curing of the adhesive.

In a case of a UV curing adhesive, the substrates are joined, and the adhesive is then irradiated with a prescribed amount of ultraviolet rays through a substrate with a UV-transmittivity to cure the adhesive. Then, each of the joined substrates can be further warmed to sufficiently promote the curing of the adhesive.

A joined substrate 1008 can be obtained by the above procedure.

Next, a support substrate 1004 of the joined substrate 1008 is removed (FIG. 10d). As a method of the removal, it is possible to employ a method of combining back-grinding and dry etching. It is thus possible to obtain the second flow path substrate 604.

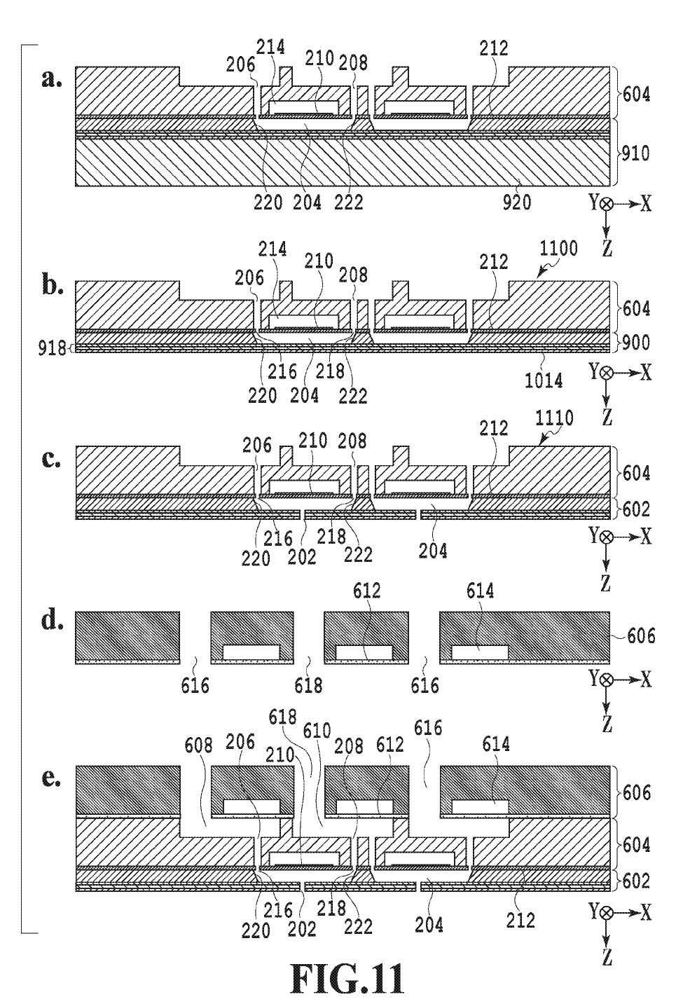

Next, a process of manufacturing the liquid ejection head of the first embodiment of the present disclosure will be described with reference to FIGS. 11a-11e.

As illustrated in FIG. 11a, the nozzle flow path forming substrate 910 described using FIGS. 9a-9c and the second flow path substrate 604 described using FIGS. 10a-10d are joined. For the joining, a known method such as wafer joining or joining with an adhesive can be used. A specific method is as described above.

Next, the support substrate 920 of the nozzle flow path forming substrate 910 is removed by grinding and dry etching to thereby preparing a substrate 1100 as illustrated in FIG. 11b.

The nozzles 202 are formed in the nozzle forming layer 918 in the obtained substrate 1100 (FIG. 11c). As a method of forming the nozzles, a resist is patterned on the oxide film 914' of the nozzle forming layer 918. The nozzle forming layer 918 is processed by dry etching using the bosch process by using the patterned resist as a mask. In this manner, the nozzles 202 are formed in the nozzle forming layer 918. In this manner, an ejection flow path substrate 1110 including the first flow path substrate 602 and the second flow path substrate 604 is obtained.

Next, the third flow path substrate 606 is prepared (FIG. 11d). The third flow path substrate 606 includes the dampers 612 that reduce variations in rear pressure at the time of liquid ejection and the damper cavities 614 for making the dampers movable as illustrated in FIG. 6. The third flow path substrate 606 includes the second common supply flow paths 616 and the second common collecting flow path 618. These are connected to the first common supply flow paths 608 and the first common collecting flow path 610 in the second flow path substrate 604, respectively.

The parts corresponding to the damper cavities, the second common supply flow paths 616 and the second common collecting flow path 618 in the third flow path substrate 606 can be formed by a method similar to the processing method described for the production of the flow path substrate 1000 in FIG. 11a. As a method of forming the dampers 612, dry-film damper members are laminated on the third flow path substrate with the parts corresponding to the second common supply flow paths, the second common collecting flow path, and the damper cavities and the like formed therein first. Then, a resist film is formed on the damper members and is then patterned. Next, the damper members are processed by dry etching to remove the resist. The dampers 612 can thus be formed.

As another method, the following procedure can also be used. First, a support substrate (for example, a silicon substrate) with an oxide film formed thereon is prepared, and a damper material is applied to the substrate by spin coating to form a film of the damper material. The obtained film is baked and cured. A resist film is formed on the obtained cured film and is then patterned by photolithography. The cured film is processed by dry etching using the patterned resist as a mask. In this manner, the cured film is patterned. The resist is removed from the patterned cured film thereby obtaining a damper film. The support substrate with the damper film is bonded to the third flow path substrate with the parts corresponding to the second common supply flow paths, the second common collecting flow path, and the damper cavities, and the like via an adhesive. Thereafter, the support substrate is ground by a back-grinding apparatus with a thickness of several tens of μm left, and silicon is entirely etched and removed using the oxide film on the support substrate as an etching stop layer. The oxide film used as the etching stop layer can be removed with a buffered hydrofluoric acid.

The thus obtained substrate is divided into individual chips to thereby obtain the third flow path substrate.

Next, the above-described first flow path substrate, second flow path substrate, and third flow path substrate are joined. For the joining, it is possible to use the joining with the adhesive described in FIG. 10, for example.

It is possible to obtain the liquid ejection head of the first embodiment by the above procedure.

### Second Embodiment of Method of Manufacturing Liquid Ejection Head

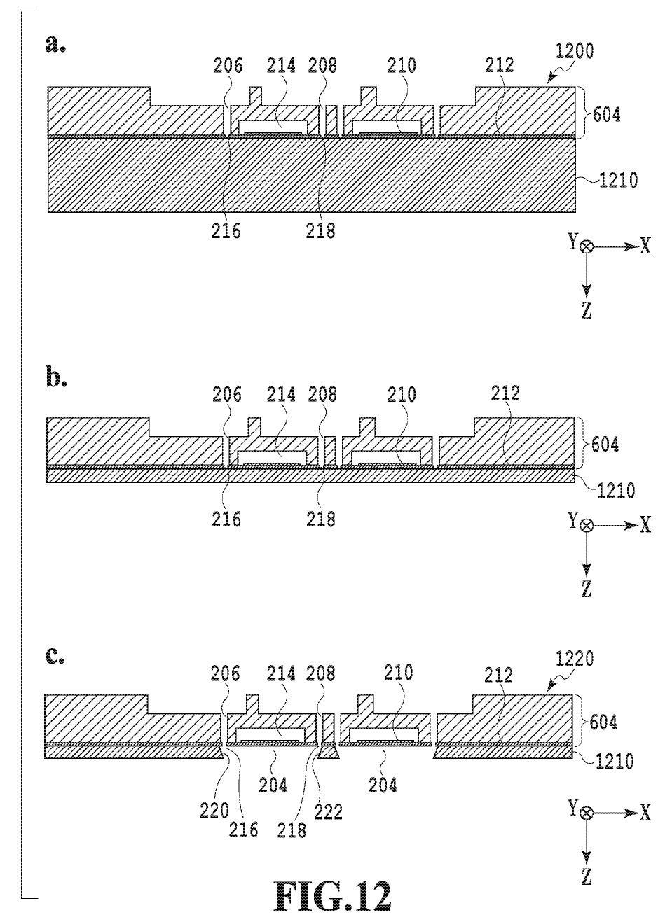

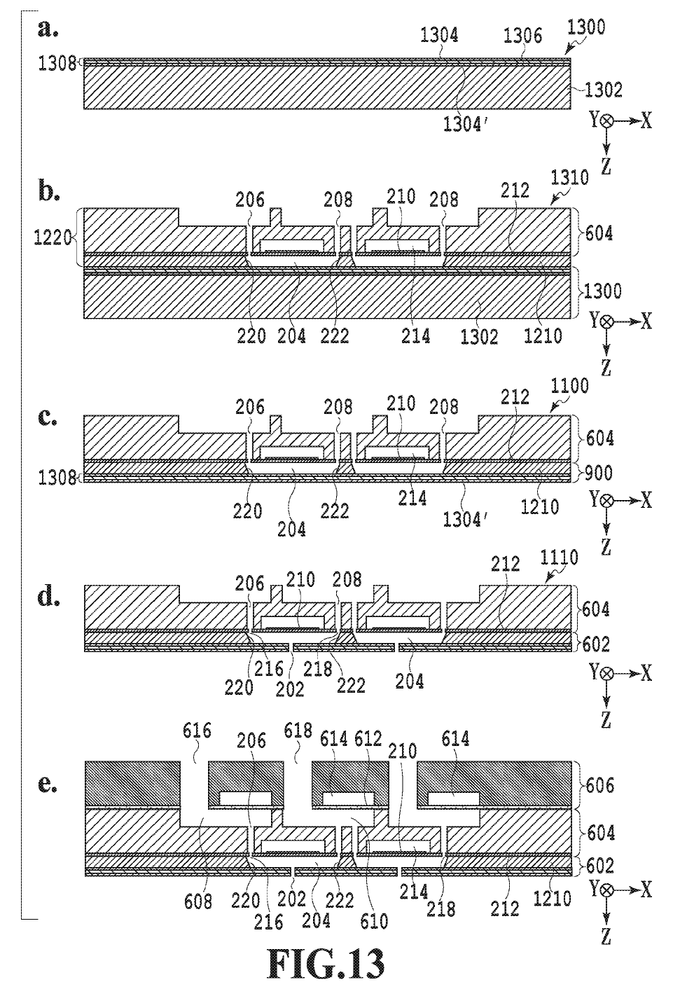

This embodiment is another process of manufacturing the liquid ejection head of the first embodiment. The manufacturing method of the present embodiment will be described with reference to FIGS. 12 and 13.

The second flow path substrate 604 is prepared in accordance with the first embodiment of the manufacturing method.

As illustrated in FIG. 12a, the second flow path substrate 604 and a silicon wafer (support substrate) 1210 are joined to each other to form a nozzle forming substrate 1200. For the joining, the method described in the first embodiment, such as the joining with the adhesive, can be used. Next, the support substrate 1210 is ground to a desired thickness as illustrated in FIG. 12b. As the grinding illustrated in FIG. 12b, the above-described method such as back-grinding can be used.

Next, the nozzle flow paths 204 are formed in the ground support substrate 1210 to give a substrate 1220 with the nozzle flow paths as illustrated in FIG. 12c. As a method of forming the nozzle flow paths, a resist material is applied to the support substrate 1210 first and is then patterned by photolithography. The bosch process is used on exposed silicon of the support substrate to form the nozzle flow paths 204 having a sectional shape spreading in the etching advancing direction (the direction toward the vibrating plates 212 (-Z direction)). It is possible to form the support substrate 1210 having the nozzle flow paths 204 of the present embodiment by setting the etching time for forming the nozzle flow paths 204 to be longer than the time in a case where the walls of the nozzle flow paths are orthogonally formed. The support substrate 1210 includes the nozzle flow paths 204 having an inverted trapezoidal shape as illustrated in FIG. 12c. According to the method, the inclination angles (θ₁ and θ₂) of the inclined surfaces 220 and 222 of the nozzle flow paths 204 can be set to be equal to or greater than 25° and less than 90°. In one embodiment of the present disclosure, these inclination angles (θ₁ and θ₂) can be set to the range of values equal to or greater than 50° and less than 90°. In one embodiment, the inclination angles (θ₁ and θ₂) can be set to the range of values equal to or greater than 70° and less than 90°.

Next, a substrate 1300 for providing nozzles as illustrated in FIG. 13a is prepared. The substrate 1300 includes a support substrate 1302 and an SOI substrate layer 1308 including an oxide film 1304, a silicon layer 1306, and an oxide film 1304'. The substrate 1300 for providing the nozzles can be obtained by a known method.

As illustrated in FIG. 13b, the substrate 1220 including the nozzle flow paths 204 obtained by the procedure described with reference to FIGS. 12a-12c and the substrate 1300 for providing the nozzles obtained in FIG. 13a are joined by wafer joining. For the joining, the above-described joining method can be selected and used. Next, the support substrate 1302 is removed by grinding and dry etching as illustrated in FIG. 13c Then, a resist is patterned on the oxide film 1304' of the obtained substrate 1100. The SIO substrate layer 1308 is processed by dry etching using the bosch process by using the patterned resist as a mask. In this manner, the nozzles 202 are formed in the SOI substrate layer 1308, and the ejection flow path substrate 1110 including the first flow path substrate 602 including the nozzles 202 and the second flow path substrate 604 is obtained (FIG. 13d). The obtained ejection flow path substrate 1110 can be divided from a wafer into individual chips.

Next, the obtained ejection flow path substrate 1110 is joined to the third flow path substrate 606 to thereby obtain the liquid ejection head of the first embodiment (FIG. 13e). For the joining, the above-described joining method can be selected and used.

### Third Embodiment of Method of Manufacturing Liquid Ejection Head

A third embodiment of a manufacturing method of the present disclosure is a method of manufacturing the liquid ejection head of the second embodiment.

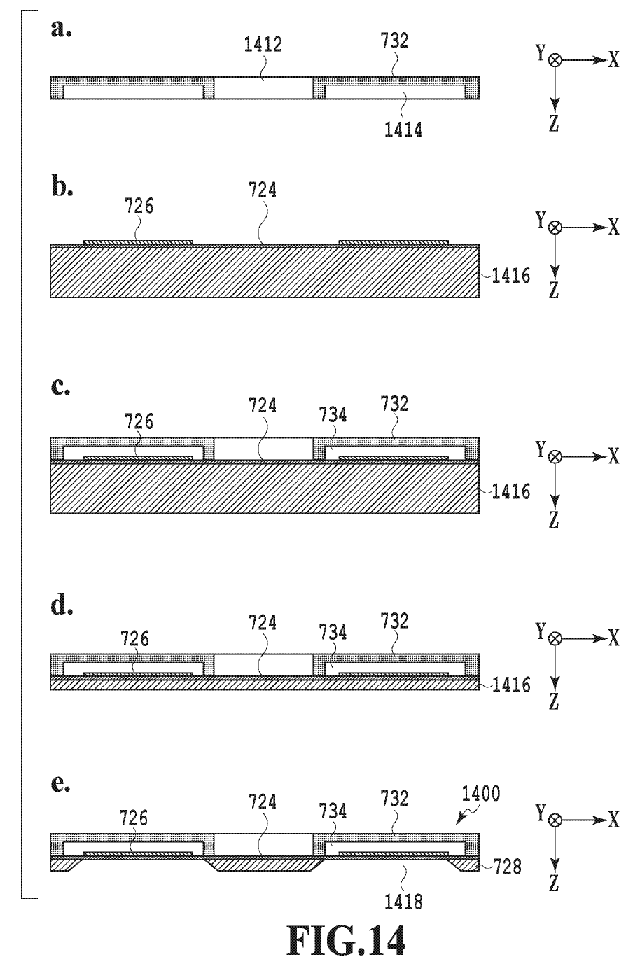

The third embodiment of the manufacturing method of the present disclosure will be described with reference to FIGS. 14-16.

The liquid ejection head of the second embodiment has the structure described using FIG. 7. The liquid ejection head of the second embodiment is produced by joining the first flow path substrate 702, the second flow path substrate 704, and the individual nozzle flow path 706 illustrated in FIG. 7.

First, protective substrates 732 as illustrated in FIG. 14a are provided. Parts 1414 corresponding to the individual cavities 734 to protect the energy generating elements 210 and a connection terminal opening portion 1412 for causing the electrical connecting portion to be exposed are formed in the protective substrates 732. As a material of the protective substrates 732, silicon substrates can be used. Examples of a method of forming each above-described element include dry etching using the bosch process and a method of combining wet etching with an alkaline aqueous solution and a formation of a through hole by leaser. Examples of the alkaline aqueous solution to be used for the wet etching include tetramethylammonium hydroxide (TMAH) and alkali metal hydroxide (for example, potassium hydroxide (KOH)). As the silicon substrates of the protective substrates 732, silicon substrates having crystal planes (100) or (110) can be used. In a case where anisotropic etching using an alkaline aqueous solution is performed as etching, the crystal plane (110) that allows vertical walls to be formed can be used.

Next, a silicon substrate 1416 is provided as illustrated in FIG. 14b. The energy generating elements 210, the vibrating plates 212, and the wirings and the electrical connecting portions (not illustrated) for connecting the driver ICs are formed on the silicon substrate. As the silicon substrate 1416, it is possible to use silicon with a crystal plane (100) or (110) similarly to the protective substrates 732. The energy generating elements 210, the vibrating plates 212, and the like on the silicon substrate 1416 can be produced by methods similar to the production methods thereof described using FIG. 10b.

Next, the silicon substrate 1416 with the energy generating elements 210, the vibrating plates 212, the driver ICs, and the like formed thereon is joined to the protective substrates 732 via an adhesive as illustrated in FIG. 14c. Thereafter, the silicon substrate 1416 is ground to a desired thickness as illustrated in FIG. 14d.

Next, a resist is applied to the ground surface of the silicon substrate 1416 and is patterned by photolithography to form an etching mask. Parts 1418 corresponding to the pressure chambers 716 are formed in the silicon substrate 1416 by performing etching via the mask. Next, the resist is removed to thereby obtain a pressure chamber forming substrate 1400 (FIG. 14e). The obtained pressure chamber forming substrate 1400 may be provided with openings with a cut line shape for division into chips as needed. As a method of providing the openings with a cut line shape, it is possible to employ dry etching using the bosch process or a method of combining wet etching with an alkaline aqueous solution and formation of a through hole by leaser. Examples of the alkaline aqueous solution to be used for the etching include tetramethylammonium hydroxide (TMAH) and alkali metal hydroxide (for example, potassium hydroxide (KOH)). After the resist is removed, a part to come into contact with a liquid such as ink on the exposed side of the silicon substrate 1416 may be protected by a protective film. As a method of forming the protective film, it is possible to employ a film forming method such as a chemical vapor deposition (CVD) method, a sputtering method, or an atomic layer deposition (ALD) method. Among the methods, the atomic layer deposition method with satisfactory conformality can be adopted. For the protective film against the liquid such as ink, it is possible to use, as a material, an oxide of metal such as Ti, Zr, Hf, V, Nb, and Ta, for example. As for metal oxides, it is possible to combine oxides of the plurality of kinds of metals. In particular, the material can be tantalum oxide (TaO). Note that electrical properties change if the electrical connecting portions include films containing such metal oxides. Therefore, protective films against a liquid such as ink are not provided at the electrical connecting portions. Examples of a film forming method not to provide the protective films at the electrical connecting portions include film formation using a one-side ALD apparatus and a method of forming the protective films after providing protective tapes on the side of the protective substrates. The obtained substrate can be divided into individual pieces as chips.

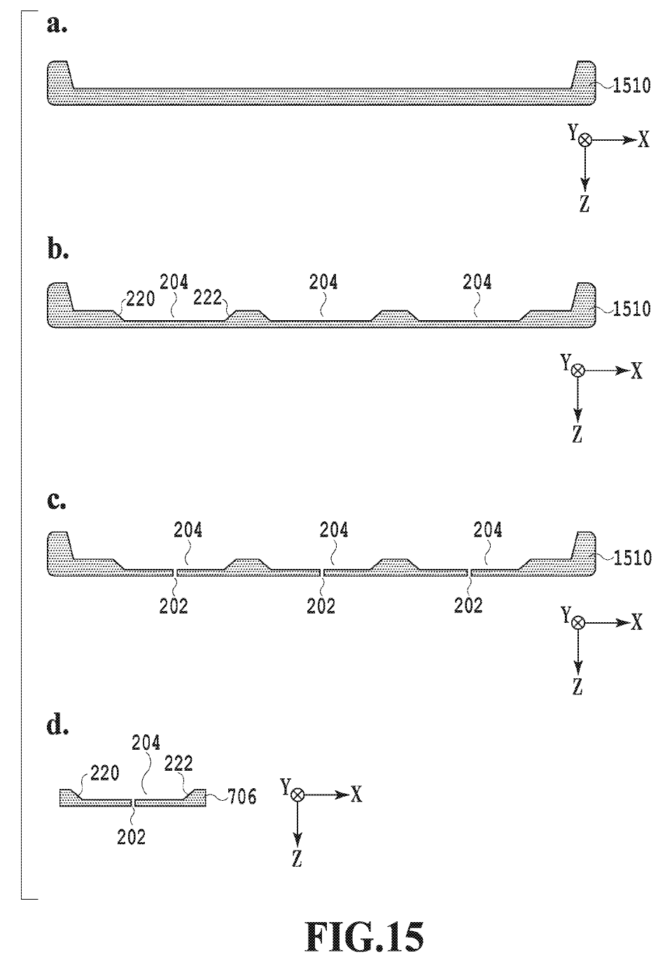

Next, a process of manufacturing the individual nozzle flow path 706 will be described with reference to FIG. 15. First, a nozzle plate 1510 is prepared as illustrated in FIG. 15a.. As the nozzle plate 1510, it is possible to use a silicon substrate of a crystal plane (100) or (110) similarly to the protective substrates 732. Next, the plate is ground with an outer peripheral portion of the nozzle plate 1510 left as illustrated in FIG. 15b.. In the grinding, only the inside of the nozzle plate 1510 is thinned to a desired thickness using a TAIKO process (registered trademark of DISCO Corporation). A resist is applied to the thinned plate portion and is patterned by photolithography. In this manner, an etching mask is formed inside the thinned plate. The nozzle flow paths 204 are formed by performing etching through the mask. A method of forming the nozzle flow paths 204 is similar to the first embodiment of the manufacturing method of the present disclosure. It is thus possible to obtain the nozzle flow paths 204 with the inclined surfaces 220 and 222.

Next, the resist is removed, and an etching mask is then formed on the surface on the side opposite to the nozzle flow paths 204 using a resist material. The nozzles 202 are formed by etching via the mask. A method of forming the nozzles 202 is as described in the first embodiment. Then, a protective film against a liquid such as ink can be formed inside the thinned plate of the nozzle plate 1510 or the part corresponding to each nozzle flow path 204. Then, the obtained plate with nozzles is divided into chips of the individual nozzle flow paths. It is thus possible to obtain the individual nozzle flow path 706.

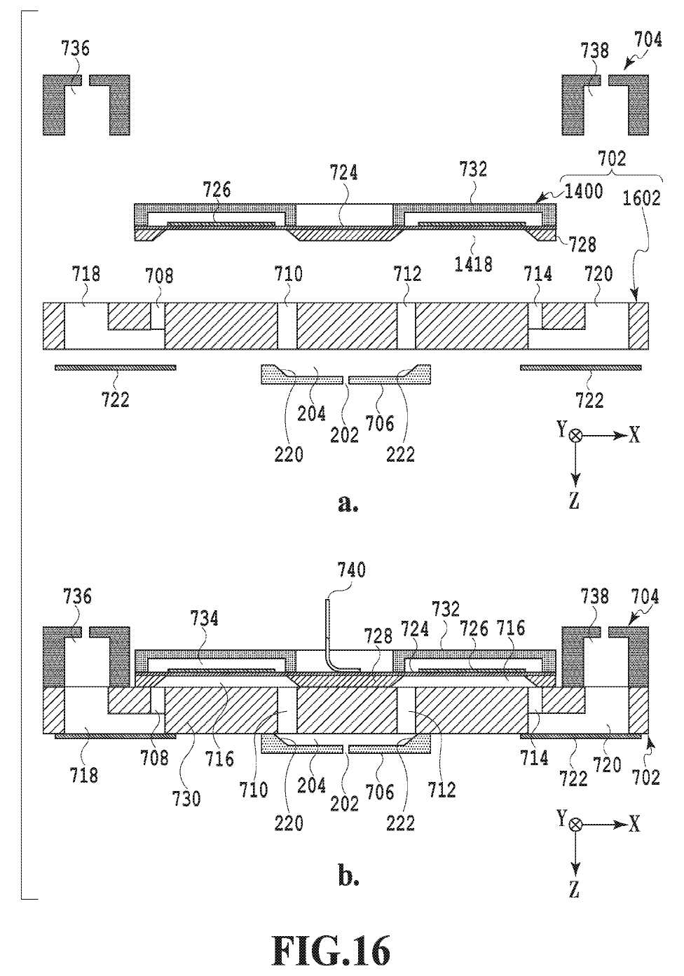

Next, a process of manufacturing the liquid ejection head of the second embodiment of the present disclosure will be described with reference to FIG. 16.

First, a flow path substrate 1602 is provided as illustrated in FIG. 16a. As the flow path substrate 1602, it is possible to use a silicon substrate of a crystal plane (100) or (110). The common flow paths 718 and 720 and the individual flow paths 708, 710, 712, and 714 are formed in the flow path substrate 1602. As a method of forming these flow paths, it is possible to employ dry etching using the bosch process or a method of combining wet etching with an alkaline aqueous solution and formation of a through hole by leaser. Examples of the alkaline aqueous solution to be used for the etching include tetramethylammonium hydroxide (TMAH) and alkali metal hydroxide (for example, potassium hydroxide (KOH)). After the common flow paths 718 and 720 and the individual flow paths 708, 710, 712, and 714 are formed, a protective film against a liquid such as ink can be formed on each above-described flow path. The formation of the protective film can be performed by the method described above. Thereafter, the obtained flow path substrate 1602 can be divided into individual pieces. Next, the pressure chamber forming substrate 1400 described using FIG. 14, the flow path substrate 1602, and the dampers 722 are joined to produce the first flow path substrate 702.

Next, the second flow path substrates 704 are provided, and the first flow path substrate 702 and the individual nozzle flow path 706 are joined using an adhesive to thereby obtain the liquid ejection head of the second embodiment.

As another procedure, each of the pressure chamber forming substrate 1400, the flow path substrate 1602, the second flow path substrates 704, the dampers 722, and the individual nozzle flow path 706 is provided as illustrated in FIG. 16a. Then, these are joined using an adhesive to thereby obtain the liquid ejection head of the second embodiment.

A driving driver IC is electrically connected to the obtained liquid ejection head, and a circulation system for circulating a liquid such as ink is further connected thereto to thereby obtain a liquid ejection head including the circulation system.

### Fourth Embodiment of Method of Manufacturing Liquid Ejection Head

A fourth embodiment of a manufacturing method of the present disclosure is a method of manufacturing the liquid ejection head of the third embodiment (the liquid ejection head illustrated in FIG. 8).

The liquid ejection head of the third embodiment can be manufactured by a procedure that is similar to that of the above-described method of manufacturing the liquid ejection head of the first embodiment without providing the individual collecting flow paths, the first common collecting flow path, and the second common collecting flow path. For example, each of elements of the first flow path substrate, the second flow path substrate, and the third flow path substrate is formed such that the elements are horizontally symmetrically disposed with respect to the center of the liquid ejection head as illustrated in FIG. 8. Next, the first flow path substrate, the second flow path substrate, and the third flow path substrate are joined as in the above-described first embodiment of the manufacturing method of the present disclosure.

### EXAMPLES

Hereinafter, the liquid ejection head of the present disclosure will be described in more detail on the basis of examples. The following examples are not intended to limit the liquid ejection head of the present disclosure to a specific embodiment.

### Example 1

This example is an example in which the liquid ejection head of the first embodiment of the present disclosure is manufactured (see FIGS. 9-11).

First, the flow path substrate 1000 in the second flow path substrate 604 was prepared (FIG. 10a). A silicon substrate with a thickness of 600 μm was provided, and dry etching using the bosch process was performed on both surfaces thereof to form the flow path substrate 1000 including the first common supply flow paths, the individual supply flow paths 206, parts 214' corresponding to the individual cavities, the individual collecting flow paths 208, and the first common collecting flow path.

Next, the actuator substrate 1002 was provided wherein the actuator substrate 1002 includes the energy generating elements 210 and electrodes (not illustrated) on a substrate with the oxide film 1006 and the vibrating plates 212 laminated on the support substrate 1004 (FIG. 10b). For The support substrate 1004 and the vibrating plates 212, silicon was used. For the piezoelectric bodies of the energy generating elements 210, lead zirconate titanate (PZT) films were used. Additionally, the upper electrodes and the lower electrodes to be connected to the lead zirconate titanate (PZT) films, the electrical connecting portions to be connected to the driver ICs, the wirings connecting the upper electrodes and the lower electrodes to the electrical connecting portions, the interlayer insulating films, and the like were formed by known methods. The openings 216 and 218 corresponding to the individual supply flow paths 206 and the individual collecting flow paths 208 in the second flow path substrate 604, respectively, were formed in the vibrating plates 212 and the oxide film 1006 by dry etching (FIG. 10b).

Next, an adhesive was film-transferred to the joining surface of the flow path substrate 1000 to form an adhesive layer. Then, the flow path substrate 1000 with the adhesive applied thereto and the actuator substrate 1002 were joined by wafer joining, and the adhesive was thermally cured (FIG. 10c). As the adhesive, benzocyclobutene (BCB) was used.

Next, the support substrate 1004 of the actuator substrate 1002 was ground to a thickness of 10 μm by back-grinding. Thereafter, the remaining support substrate 1004 was removed by dry etching using the oxide film 1006 between the vibrating plates 212 and the support substrate 1004 as a stop layer without providing a resist mask. In this manner, the second flow path substrate 604 was obtained.

Next, the nozzle flow path forming substrate 910 in which the support substrate 920, the oxide film 914, the silicon layer 916, the oxide film 914', and the nozzle flow path layer 912 were laminated was provided (FIG. 9a). A novolac-type photoresist was applied to the nozzle flow path forming substrate 910 on the side of the nozzle flow path layer, and exposure and development were performed to thereby form a resist film having an opening pattern. For the support substrate, the silicon layer, and the nozzle flow path layer, silicon was used.

Next, dry etching using the bosch process was used to form the nozzle flow paths 204 (FIG. 9b). As etching conditions, the passivation process time was set to 10 seconds per cycle, and the etching process time was set to 10 seconds per cycle. The cycle was repeated. As conditions of reactive ion etching at this time, the gas pressure (absolute pressure) of a degree of vacuum was 5 Pa, the flow amount of SF₆ gas was 500 sccm, and the flow amount of C₄F₈ gas was 500 sccm. Under these conditions, the nozzle flow path was formed to have a shape in which the width was narrowed in the etching advancing direction. In this case, the inclination angles 224 (θ₁) and 226 (θ₂) of the inclined surfaces 220 and 222 of the nozzle flow path were 80°.

Next, an adhesive was film-transferred to the nozzle flow path forming substrate 910 with the nozzle flow paths 204. The adhesive was applied to the side on which the nozzle flow paths were formed. The nozzle flow path forming substrate 910 to which the adhesive applied and the second flow path substrate 604 obtained in accordance with the above-described procedure were wafer-joined, and the adhesive was then thermally cured (FIG. 11a). As the adhesive, benzocyclobutene (BCB) was used.

Next, the support substrate 920 of the nozzle flow path forming substrate 910 was ground to a thickness of 10 μm by back-grinding. Then, the remaining support substrate 920 was removed by dry etching using the oxide film 914' between the silicon layer 916 and the support substrate 920 as a stop layer without providing a resist mask. Thereafter, the nozzles 202 were formed on the side of the first flow path substrate by dry etching using the bosch process. The obtained substrate was divided into individual pieces by dicing to thereby obtain the ejection flow path substrate 1110 (FIG. 11c).

Separately, the third flow path substrate 606 including the second common supply flow paths 616, the second common collecting flow path 618, and the dampers 612 using polyimide films was provided. The third flow path substrate 606 was joined to the ejection flow path substrate 1110 to thereby obtain a liquid ejection head chip (FIG. 11e). A driving driver IC was electrically connected to the liquid ejection head chip, and a supply system including an ink circulation system was connected to the liquid ejection head chip thereby obtaining a liquid ejection head.

According to the liquid ejection head in the present example, the inclined surfaces 220 and 222 of the nozzle flow paths 204 formed by the dry etching using the bosch process suppressed concentration of a liquid, and it was possible to realize stabilization of an ejecting function.

### Example 2

This example is another embodiment (the example of FIG. 3B) of the nozzle flow paths 204 in Example 1. Therefore, processes other than the method of forming the nozzle flow paths 204 are similar to those in Example 1. Therefore, description of overlapping processes will be omitted.

The Nozzle flow path forming substrate 910 in which the support substrate 920, the oxide film 914, the silicon layer 916, the oxide film 914', and the nozzle flow path layer 912 were laminated was provided. A novolac-type photoresist was applied to the nozzle flow path forming substrate 910 on the side of the nozzle flow path layer. The obtained resist film was exposed and developed to form an opening pattern. For the support substrate, the silicon layer, and the nozzle flow path layer, silicon was used. For the silicon layer 916, in particular, a silicon crystal with a crystal plane (100) was used.

Next, protective films were formed at wafer edges of the support substrate surface and the silicon layer, an aqueous solution (concentration of 22%) of tetramethylammonium hydroxide (TMAH) was warmed to 83° C., and the nozzle flow paths 204 were formed by anisotropic etching. The inclination angles 224 (θ₁) and 226 (θ₂) of the inclined surfaces 220 and 222 of the obtained nozzle flow paths 204 were 54.7°.

### Example 3

This example is an example of another embodiment (FIG. 4) of the nozzle flow paths 204 in Example 1. Therefore, processes other than the method of forming the nozzle flow paths 204 are similar to those in Example 1. Therefore, description of overlapping processes will be omitted.

A nozzle flow path forming substrate 910 in which the support substrate 920, the oxide film 914, the silicon layer 916, the oxide film 914', and the nozzle flow path layer 912 were laminated was provided. A novolac-type photoresist was applied to the nozzle flow path forming substrate 910 on the side of the nozzle flow path layer. The obtained resist film was exposed and developed to form an opening pattern. For the support substrate, the silicon layer, and the nozzle flow path layer, silicon was used. For the silicon layer 916, in particular, a silicon crystal with a crystal plane (110) was used.

Next, protective films were formed at wafer etches of the support substrate surface and the silicon layer, an aqueous solution (concentration of 22%) of tetramethylammonium hydroxide (TMAH) was warmed to 83° C., and the nozzle flow paths 204 were formed by anisotropic etching. The inclination angles 224 (θ₁) and 226 (θ₂) of the inclined surfaces 220 and 222 of the obtained nozzle flow paths 204 were 28.1°.

### Example 4

This example is another example in which methods of forming the nozzle flow paths 204 and the nozzles 202 are different from those in Example 1. The other processes are similar to those in Example 1. Therefore, description of overlapping processes will be omitted.

The nozzle forming substrate 1200 including the second flow path substrate 604 and the silicon wafer (support substrate) 1210 was prepared (FIG. 12a). The nozzle forming substrate 1200 can be formed by joining the second flow path substrate 604 and the silicon wafer (support substrate) 1210. For the joining, it is possible to use a known method such as joining with an adhesive. The support substrate 1210 of the nozzle forming substrate 1200 was ground by back-grinding with the thickness of 100 μm left (FIG. 12b).

Next, a novolac-type photoresist was applied to the surface on the side of the support substrate 1210, and exposure and development were performed to form opening patterns corresponding to the nozzle flow paths 204.

Next, the nozzle flow paths 204 were formed in the support substrate 1210 by dry etching using the bosch process thereby obtaining the substrate 1220 including the nozzle flow paths (FIG. 12c). As etching conditions, the passivation process time was set to 5 seconds per cycle, and the etching process time was set to 25 seconds per cycle. This cycle was repeated. As conditions of the reactive ion etching, the gas pressure (absolute pressure) of a degree of vacuum was 5 Pa, the flow amount of SF₆ gas was 500 sccm, and the flow amount of C₄F₈ was 500 sccm. The parts to serve as the nozzle flow paths were formed in a shape in which the width increased in the etching advancing direction by the above conditions of the reactive ion etching. In this case, the inclination angles 224 (θ₁) and 226 (θ₂) of the inclined surfaces 220 and 222 of the nozzle flow paths were 80°.

Next, the substrate 1300 for providing the nozzles was prepared, and the substrate 1300 includes the oxide film 1304, the silicon layer 1306, and the oxide film 1304' were laminated on the support substrate 1302 (FIG. 13a). The substrate 1300 for providing the nozzles included the SOI substrate layer 1308 including the oxide film 1304, the silicon layer 1306, and the oxide film 1304'. The substrate 1300 for providing the nozzles and the substrate 1220 including the nozzle flow paths were wafer-joined via an adhesive to thereby obtain a joined substrate 1310 (FIG. 13b). Then, the adhesive was thermally cured. As the adhesive, benzocyclobutene (BCB) was used.

Next, the support substrate 1302 of the joined substrate 1310 obtained as described above was ground to a thickness of 10 μm (FIG. 13c). Then, the support substrate 1302 was removed by dry etching using the oxide film 1304' in the SOI substrate layer 1308 as a stop layer without providing a resist mask. Thereafter, the nozzles 202 were formed in the SOI substrate layer 1308 by dry etching using the bosch process (FIG. 13d).

### Example 5

This example is an example in which the liquid ejection head having the structure illustrated in FIG. 7 is manufactured. Hereinafter, description will be given with reference to FIGS. 14-16.

As illustrated in FIG. 14, the pressure chamber forming substrate 1400 was formed. First, the protective substrates 732 including the parts 1414 corresponding to the individual cavities 734 were provided as illustrated in FIG. 14a.. The protective substrates 732 are silicon substrates with crystal planes (110) and with a thickness of 400 μm and have thermal oxide films (not illustrated) on the silicon substrates. Resist films were formed on the thermal oxide films. The resist films have opening patterns which correspond to the parts 1414 corresponding to the individual cavities 734 for protecting the energy generating elements and the connection terminal opening portions 1412 for exposing connection terminals (not illustrated) connected to the wiring substrate. The openings were formed by anisotropic etching using potassium hydroxide (KOH).

Next, a substrate including the vibrating plates 212 and the energy generating elements 210 on the silicon substrate 1416 was provided as illustrated in FIG. 14b. Although not illustrated in FIG. 14b, it is possible to provide the upper electrodes, the lower electrodes, the wirings, the connection terminals, and a base layer between the lower electrodes and the vibrating plates 212 on the silicon substrate. Silicon with a crystal plane (110) was used for the silicon substrate 1416, SiO₂ was used for the vibrating plates, lead zirconate titanate (PZT) was used for the energy generating elements, Ir was used for the upper electrodes and the lower electrodes, Au was used for the wirings and the connection terminals, and zirconium oxide (ZrO₂) was used for the base layer.

Next, the protective substrates 732 and the silicon substrate 1416 including the vibrating plates 212, the energy generating elements 210, and the like were joined by wafer joining using an adhesive as illustrated in FIG. 14c. A joined substrate was thus obtained. As the adhesive used for the joining, an amide-based adhesive was used. The application of the adhesive was performed by preparing adhesive sheets applied to films and transferring the adhesive to the joining surfaces of the protective substrates 732.

Next, the silicon substrate 1416 of the obtained joined substrate was ground to a thickness of 70 μm as illustrated in FIG. 14d. Thereafter, patterns corresponding to the pressure chambers were formed by photoresist on the side of the silicon substrate as illustrated in FIG. 14e. Next, potassium hydroxide (KOH) was used to form the parts 1418 corresponding to the pressure chambers by wet etching to thereby obtain the pressure chamber forming substrate 1400. In this case, openings to divide the obtained pressure chamber forming substrate 1400 into individual pieces were provided on a dicing line. Also, tantalum oxide (TaO) film was formed as a protective film on the obtained pressure chamber forming substrate on the side of the silicon substrate. Then, the substrate on which the tantalum oxide (TaO) film was formed was divided into individual pieces by laser stealth dicing.

Next, a silicon substrate with a crystal plane (110) to serve as the nozzle plate 1510 was provided and ground such that the thickness of the plate inside became 130 μm with plate end portions left by 2 mm as illustrated in FIG. 15a.

Next, a resist film having opening patterns corresponding to the nozzle flow paths was formed by photolithography using a resist inside the recesses as illustrated in FIG. 15b. The nozzle flow paths 204 with a depth up to 100 μm were formed by performing anisotropic etching with potassium hydroxide (KOH) using the resist film as a mask. The inclination angles of the inclined surfaces 220 and 222 of the nozzle flow paths were 28.1°.

Next, the nozzles 202 were formed by dry etching using the bosch process from the surface on the side opposite to the parts serving as the nozzle flow paths 204 as illustrated in FIG. 15c.

Next, the substrate obtained as described above was divided into individual pieces by laser stealth dicing as illustrated in FIG. 15d.

As illustrated in FIG. 16a, the flow path substrate 1602 made of a silicon substrate with a crystal plane (110) was formed. As the flow path substrate 1602, the common flow paths 718 and 720 and the individual flow paths 708, 710, 712, and 714 were formed in the silicon substrate by formation of a through hole by laser and anisotropic etching using potassium hydroxide (KOH). Also, the second flow path substrate 704 including the flow paths 736 and 738 and the dampers 722 were separately provided. The above-described individual nozzle flow path 706, the pressure chamber forming substrate 1400 obtained by the procedure described in FIG. 14, the flow path substrate 1602, and the dampers 722 were joined using an adhesive. Thereafter, the wiring substrate to which the driver ICs were connected, the connection terminals, and the like were connected to the obtained liquid ejection head chip, and a liquid supply unit and a liquid circulation unit were further connected to the obtained liquid ejection head chip.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it is possible to suppress concentration of the liquid and to stabilize ejection performance by reducing stagnation of the liquid in the nozzle flow path.

This application claims the benefit of Japanese Patent Application No. 2024-197746, filed Nov. 12, 2024, which is hereby incorporated by reference herein in its entirety.

What is claimed is:

1. A liquid ejection head comprising:
a nozzle flow path comprising a nozzle for ejecting a liquid; and
an individual supply flow path for supplying the liquid, the individual supply flow path being orthogonally connected to the nozzle flow path at an end portion of the nozzle flow path in a longitudinal direction, wherein
the nozzle flow path comprises, at the end portion, a wall in a direction in which the individual supply flow path is connected, and the wall has an inclination, and
a connecting portion between the nozzle flow path and the individual supply flow path has a width W1 of an opening, the inclination of the wall in the direction of the individual supply flow path has a width S1 in the longitudinal direction of the nozzle flow path, and a part of the width W1 and a part of the width S1 overlap each other.

2. The liquid ejection head according to claim 1, wherein an angle of the inclination of the wall in the direction of the individual supply flow path is equal to or greater than 25° and less than 90°.

3. The liquid ejection head according to claim 1, further comprising:
an individual collecting flow path orthogonally connected to the nozzle flow path at another end portion of the nozzle flow path opposite to the end portion, wherein
the nozzle flow path includes the wall in the direction of the individual collecting flow path at the other end portion, and the wall in the direction of the individual collecting flow path has an inclination.

4. The liquid ejection head according to claim 3, wherein an angle of the inclination of the wall in the direction of the individual collecting flow path is equal to or greater than 25° and less than 90°.

5. The liquid ejection head according to claim 3, wherein a connecting portion between the nozzle flow path and the individual collecting flow path has a width W1 of an opening, the inclination of the wall in the direction of the individual collecting flow path has a width S1 in the longitudinal direction of the nozzle flow path, and a part of the width W1 and a part of the width S1 overlap each other.

6. The liquid ejection head according to claim 1, wherein the width S1 is included within a range of the width W1.

7. The liquid ejection head according to claim 5, wherein the width S1 is included within a range of the width W1.

8. The liquid ejection head according to claim 1, wherein the width W1 is included within a range of the width S1.

9. The liquid ejection head according to claim 5, wherein the width W1 is included within a range of the width S1.

10. The liquid ejection head according to claim 1, wherein a ratio between the width W1 and the width S1 is (S1/W1) < 4.

11. The liquid ejection head according to claim 1, wherein the liquid ejection head includes a circulation system.

12. A method of manufacturing a liquid ejection head comprising:
a nozzle flow path comprising a nozzle for ejecting a liquid, and
an individual supply flow path for supplying the liquid, the individual supply flow path being orthogonally connected to the nozzle flow path at an end portion of the nozzle flow path in a longitudinal direction,
the nozzle flow path comprising, at the end portion, a wall in a direction in which the individual supply flow path is connected, the wall having an inclination,
the method comprising:
forming the nozzle flow path; and
forming the individual supply flow path in the nozzle flow path, wherein the inclination is formed in the forming of the nozzle flow path.
